(19) United States
(12) Patent Application Publication
(10) Pub. No.: US 2011/0061808 A1
(43) Pub. Date: Mar. 17, 2011

(54) SHEET STICKING APPARATUS AND STICKING METHOD

(75) Inventor: Kan Nakata, Tokyo (JP)

(73) Assignee: LINTEC CORPORATION, Tokyo (JP)

(21) Appl. No.: 12/993,203

(22) PCT Filed: May 22, 2009
(86) PCT No.: PCT/JP2009/059411

§ 371 Date: Nov. 17, 2010

(30) Foreign Application Priority Data
Jun. 6, 2008 (JP) 2008-149067

(51) Int. Cl. B32B 37/10

(52) U.S. Cl. 156/285; 156/382

(57) ABSTRACT

A sheet sticking apparatus 10 includes: an openable and closeable case 14 for accommodating a table 11 for supporting a semiconductor wafer W, and forming a decompression chamber C therein; a feeding means 15 for feeding an adhesive sheet S to a position where the adhesive sheet S faces the semiconductor wafer W; and a sandwiching means 29 disposed, in the case 14, in a position relative to the table 11. The sandwiching means 29 sandwiches only an outer periphery portion of the semiconductor wafer W together with the adhesive sheet S by interaction with the table 11 in a state where a single decompression chamber C is formed by closing the case 14. Thereafter, the adhesive sheet S is stuck to the semiconductor wafer W by releasing the reduced pressure in the decompression chamber C.

### FIELD OF THE INVENTION

The present invention relates to a sheet sticking apparatus and a sticking method, and more particularly to a sheet sticking apparatus and a sticking method capable of sticking an adhesive sheet to an adherend under a decompression atmosphere.

### BACKGROUND OF THE ART

Conventionally, semiconductor wafers (hereinafter, simply referred to as “wafers”) are stuck with an adhesive sheet on a circuit surface and a rear surface thereof, and are subjected to various treatments such as rear-face grinding and dicing.

Patent Document 1 discloses the above adhesive sheet sticking apparatus. The apparatus is configured to form a space on each of the lower surface side of a rubber sheet for supporting a wafer and the upper surface side of a dicing sheet disposed relatively to the wafer, and, after reducing the pressures in such spaces, open one of the spaces to the atmosphere to stick the sheet to the wafer.

[Patent document 1]: Japanese Patent Application Laid-Open No. 2005-26377

### SUMMARY OF THE INVENTION

### Problem to be Solved by the Invention

However, the sheet sticking apparatus disclosed in the patent document 1 has an arrangement in which it must reduce the pressures in the spaces located on the lower and upper surface sides of the rubber sheets while keeping the pressures in the space on the lower surface side equal to that on the upper surface side. Therefore, there is such a disadvantage that this arrangement makes the pressure control thereof very complicated.

Also, the wafer is a full contact type in which the entire area on the lower surface side of the wafer is supported in contact with the rubber sheet. If any foreign object such as dust is deposited between the lower surface of the wafer and the rubber sheet, then damage to the wafer, such as a crack, is caused when a pressure for sticking the dicing sheet is applied.

### OBJECT OF THE INVENTION

The present invention has been proposed in view of the above disadvantages. It is an object of the present invention to provide a sheet sticking apparatus and a sticking method capable of sticking an adhesive sheet to an adherend without any complicated control of decompression.

Also, another object of the present invention is to provide a sheet sticking apparatus and a sticking method capable of effectively eliminate a factor in damage which may be caused when a pressure force is applied to the adherend by providing, in a limited manner, a region for supporting the adherend.

### MEANS FOR SOLVING PROBLEMS

In order to achieve the above object, the present invention adopts such an arrangement that a sheet sticking apparatus comprises a table for supporting an adherend, an openable and closeable case for accommodating the table and forming a decompression chamber in the case, and a feeding means for feeding an adhesive sheet to a position where the adhesive sheet faces the adherend, the adhesive sheet being stuck to the adherend by closing the case and performing a predetermined control of the pressure in the decompression chamber;

wherein the sheet sticking apparatus further comprising a sandwiching means disposed, in the case, in a position relative to the table, the sandwiching means being sandwiching only an outer periphery portion of the adherend together with the adhesive sheet by interaction with the table in a state where a single decompression chamber is formed by closing the case.

In the present invention, the sandwiching means is provided so as to form a space existing before sticking between the adhesive sheet and the adherend, the space being independent from the decompression chamber.

Also, the present invention adopts such an arrangement that the table comprises a supporting convex portion for supporting the outer periphery portion of the adherend from below; and the sandwiching means comprises a sandwiching convex portion corresponding to the supporting convex portion and sandwiching the adhesive sheet from top of the adhesive sheet.

Further, the present invention may adopt a sheet sticking method using a sheet sticking apparatus including a table for supporting an adherend, an openable and closeable case for accommodating the table and forming a decompression chamber in the case, and a feeding means for feeding an adhesive sheet to a position where the adhesive sheet faces the adherend, the method comprising the steps of:

supporting a plate-like member on the table; feeding an adhesive sheet to a position relative to the plate-like member; forming a decompression chamber by closing the case; reducing the pressure in the decompression chamber; sandwiching only an outer periphery portion of the plate-like member together with the adhesive sheet by interaction with the table; and sticking the adhesive sheet to the plate-like member by releasing the reduced pressure in the decompression chamber.

Furthermore, in the sheet sticking method, such a method is adopted that the outer periphery portion of the plate-like member is sandwiched together with the adhesive sheet by a supporting convex portion for supporting an outer periphery portion of the adherend from below, and a sandwiching convex portion corresponding to the supporting convex portion and sandwiching the adhesive sheet from top of the adhesive sheet.

According to the present invention, only the outer periphery portion of the adherend is sandwiched together with the adhesive sheet by the table and the sandwiching means in a state where the pressure in the decompression chamber is reduced. Therefore, the adhesive sheet is stuck to the adherend by simply controlling the pressure so as to open the decompression chamber to the atmosphere.

Thus, a plurality of pressure control valves, pipes, pressure balance control and the like, which are required in the case of providing the plurality of decompression chambers, are not required so that a complicated arrangement, pressure control, or management are not required.

Also, only the outer periphery portion is supported by the table, and therefore the adherend can have a decreased contact area between the adherend and the table. Asa result, a foreign object on the table, for example, is not pressed against the adherend, and therefore even when a fragile adherend such as a wafer is supported, the damage to the adherend can be effectively prevented.

Further, an independent space existing before sticking is formed between the adherend and the adhesive sheet by the table and the sandwiching means in a state where the pressure in the decompression chamber is reduced. Therefore, by controlling the pressure so as to open the decompression chamber to the atmosphere, the space existing before sticking substantially disappears due to the atmosphere pressure, so that the adhesive sheet is stuck to the adherend.

Note that the term “decompress” in the description is herein used as a concept including vacuum. The term “a space existing before sticking” is used to refer to a void which occurs between an adherend and an adhesive sheet in a region in which a force sandwiching the adherend and the adhesive sheet does not act.

### BRIEF DESCRIPTION OF THE DRAWINGS

FIG. 1 is a schematic cross-sectional front view showing a part of a sheet sticking apparatus of the embodiment.

FIG. 2 is a schematic plan view showing the apparatus with a part of FIG. 1 omitted.

FIG. 3 is a schematic front view showing a state where a decompression chamber is formed.

FIG. 4 is a schematic cross-sectional view showing a state where a sandwiching means sandwiches a wafer together with an adhesive sheet.

FIG. 5 is an enlarged cross-sectional view showing a state where a space existing before sticking is formed between the wafer and the adhesive sheet.

FIG. 6 is an enlarged cross-sectional view showing a state where the space existing before sticking disappears so that the adhesive sheet is stuck to the wafer.

FIG. 7 is a cross-sectional view similar to FIG. 5 but showing a variation with an adherend having a relatively large thickness in the outer periphery portion thereof.

FIG. 8 is a cross-sectional view similar to FIG. 6 but showing the variation with an adherend having a relatively large thickness in the outer periphery portion thereof.

### EXPLANATION OF REFERENCE NUMERALS

10: sheet sticking apparatus
11: table
11A: supporting convex portion
14: case
15: feeding means
29: sandwiching means
32: sandwiching convex portion
C: decompression chamber
C4: space existing before sticking
S: adhesive sheet
W: semiconductor wafer (adherend)

### DESCRIPTION OF THE PREFERRED EMBODIMENTS

Hereinafter, a preferred embodiment of the present invention will be described with reference to the drawings.

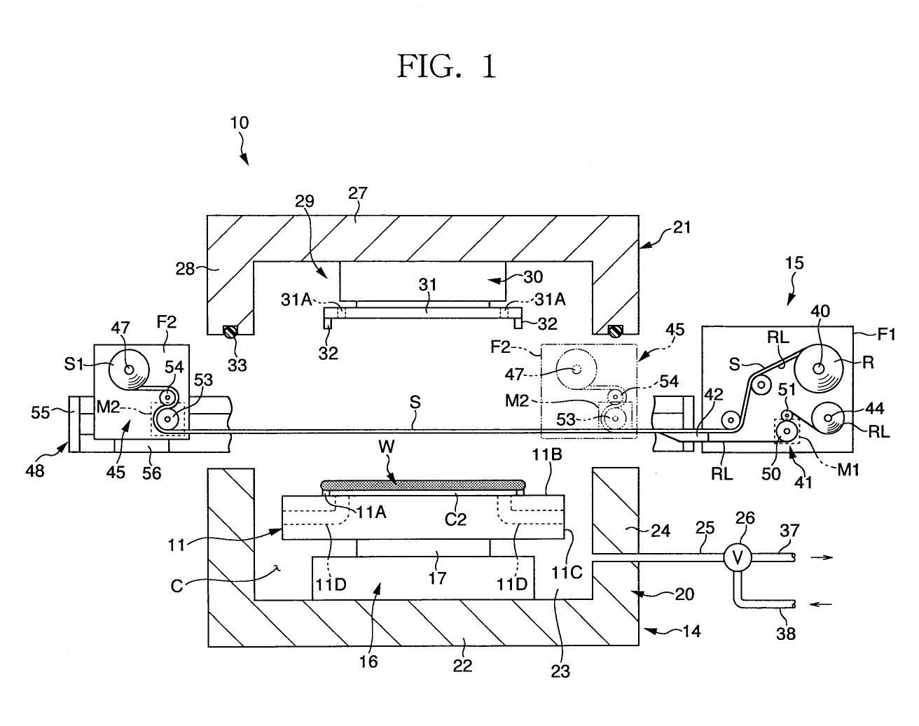

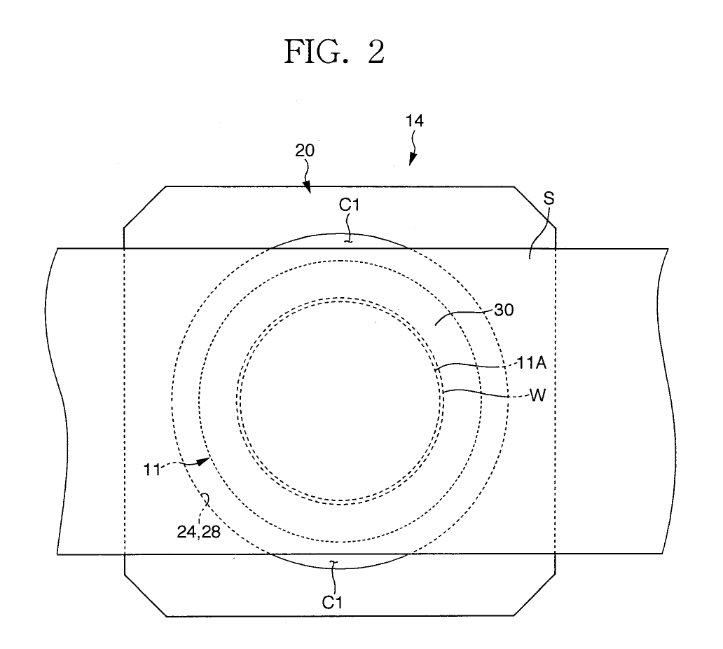

FIG. 1 shows a schematic front view of a sheet sticking apparatus according to the embodiment, and FIG. 2 shows a schematic plan view of the apparatus with a part of FIG. 1 omitted. In these figures, a sheet sticking apparatus 10 comprises: a table 11 for supporting a plate-like member, in particular a generally circular wafer W, as an adherend; an openable and closeable case 14 for accommodating the table 11 and forming a decompression chamber C therein; and a feeding means 15 for feeding an adhesive sheet S having pressure-sensitive adhesive properties to a position where the adhesive sheet S faces a adhered surface which is an upper surface of the wafer W, in an opened state of the case 14. Here, as shown in FIG. 2, the adhesive sheet S is adopted, which has a width dimension that does not separate the decompression chamber C into upper and lower portions. The adhesive sheet S forms a clearance C1 without covering the entire inner circumference area of the case 14 when fed to the position where the adhesive sheet S faces the adhered surface of the wafer W, so that the decompression chamber C is formed as a single space. Note that the clearances C1 may be a passage such as a pipe and a through-hole to prevent the decompression chamber C from being separated into a plurality of spaces.

The table 11 has a larger plane area than the size of the wafer W, and comprises, on an upper surface of the table 11, an annular supporting convex portion 11A for supporting the wafer W from below while only contacts an outer periphery portion on the lower surface side of the wafer W. Therefore, in a state where the table 11 supports the wafer W, a space C2 is formed between the lower surface side of the wafer W except the outer periphery portion thereof and an upper surface 11B of the table 11. The table 11 has a communicating hole 11D formed between an outer peripheral surface 11C and the upper surface 11B thereof. The space C2 communicates with the decompression chamber C to constitute a part of the decompression chamber C. An output shaft 17 of a linear motor 16 is fixed on the lower surface side of the table 11. The table 11 is disposed such that the table 11 can move upward and downward by driving the linear motor 16.

The case 14 comprises a first case 20 located on the lower part side in FIG. 1, and a second case 21 located on the upper part side in FIG. 1. The first case 20 comprises a bottom portion 22 for supporting the table 11 through the linear motor 16, and an erecting portion 24 which forms a generally circular recess portion 23 in a central region thereof. The first case 20 is connected to a pipe 25 and a three-way solenoid valve 26 which are connected to the erecting portion 24, and is provided so as to be able to move in a vertical direction through an elevating means (not shown). Note that the three-way solenoid valve 26 is connected to a pipe 37, which is connected to a decompression pump (not shown), and a pipe 38 for introducing the atmosphere. Thus, the three-way solenoid valve 26 can reduce the pressure in the decompression chamber C, and obtain atmospheric pressure by releasing the reduced pressure.

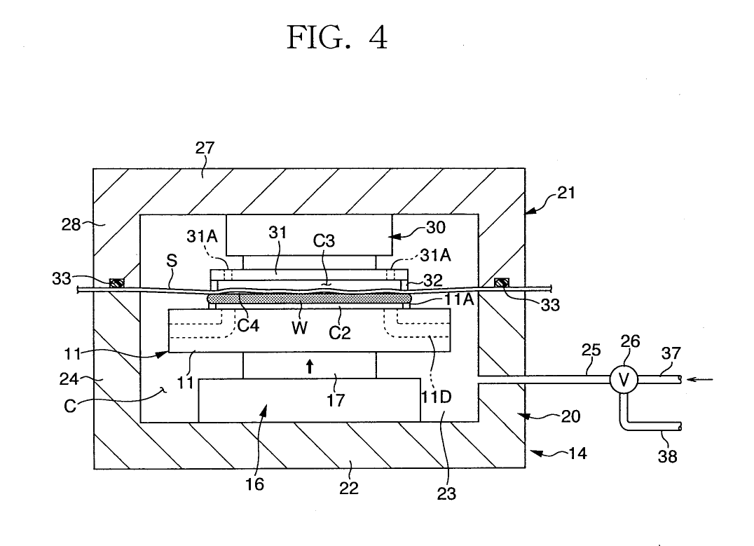

The second case 21 includes a top portion 27 and a drooping portion 28. A sandwiching means 29 is disposed on the lower surface side of the top portion 27, in a position relative to the table 11. The sandwiching means 29 includes a sandwiching plate 31 provided such that the sandwiching plate 31 can move upward and downward through a linear motor 30, and an annular sandwiching convex portion 32 provided on the outer periphery side of a lower surface of the sandwiching plate 31. The sandwiching convex portion 32 has the substantially same shape as the supporting convex portion 11A so that the sandwiching convex portion 32 is adapted to press and sandwich only an upper surface side of the outer periphery portion of the wafer W via the adhesive sheet S from top. A plurality of through-holes 31A are formed within a plane of the sandwiching plate 31. Even in a state where the sandwiching means 29 sandwiches the adhesive sheet S and the wafer W between the table 11 and the sandwiching means 29, a space C3 formed between the adhesive sheet S and the sandwiching plate 31 (see FIG. 4) communicates with the decompression chamber C to constitute a part of the decompression chamber C. Note that a lower end surface of the drooping portion 28 receives an O-ring 33 therein.

The second case 21 is supported movably in a vertical direction through a moving means (not shown). The second case 21 forms the decompression chamber C by interaction with the first case 20, when the second case 21 is lowered on the first case 20 side so that the lower end surface of the drooping portion 28 is pressed against an upper end side of the erecting portion 24.

The feeding means 15 comprises: a support roller 40 having a lock mechanism for supporting a raw sheet R with a strip-shaped release liner RL temporarily stuck to an adhesive agent layer side of a strip-shaped adhesive sheet S; a winding means 41 for collecting the release liner RL; a peel plate 42 for peeling the adhesive sheet S off from the release liner RL; a drawing and winding means 45 for drawing the adhesive sheet S to a position where the adhesive sheet S faces the adhered surface of the wafer W, i.e., the upper surface thereof, and for winding an unnecessary adhesive sheet S1 positioned on an outer side of the adhesive sheet S stuck to the wafer W; a cutting means (not shown) for cutting the adhesive sheet S stuck to the wafer W in accordance with the size of the wafer W; and a moving means 48 for supporting the drawing and winding means 45 movably in a horizontal direction in FIG. 1. Note that the cutting means may use a multi-jointed robot described in Japanese Patent Application No. 2006-115106 which has already filed by the present applicant.

The winding means 41 comprises a drive roller 50 rotated by driving of a motor M1 supported by a frame F1, a pinch roller 51 for sandwiching the release liner RL between the drive roller 50 and the pinch roller 51, and a release liner winding roller 44 for winding the release liner RL by rotating thereof in synchronism with the drive roller 50 by the motor M1.

The drawing and winding means 45 comprises a drive roller 53 rotated by driving of a motor M2 supported by a frame F2, a pinch roller 54 for sandwiching the unnecessary adhesive sheet S1 between the drive roller 53 and the pinch roller 54, and an unnecessary-sheet winding roller 47 for winding the unnecessary adhesive sheet S1 by rotating thereof in synchronism with the drive roller 53 by the motor M2.

The moving means 48 comprises a single axis robot 55 extending in a horizontal direction in FIG. 1. The frame F2 is fixed to a slider 56 of the single axis robot 55 so that the drawing and winding means 45 can move in the horizontal direction.

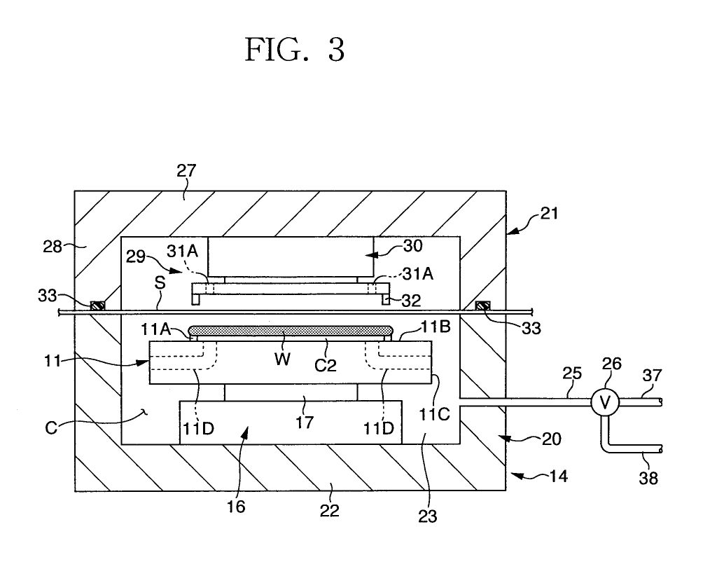

A sheet sticking method according to the embodiment will be now described with reference to FIGS. 3 to 6 as well.

First, a lead end of a raw sheet R supported by the support roller 40 is drawn by a predetermined length, in a state where the first and second cases 20, 21 are positioned away from each other to open the case 14. The release liner RL is peeled off from the adhesive sheet Sat a tip location of the peel plate 42. The release liner RL is fixed to the release liner winding roller 44. On the other hand, the adhesive sheet S is fixed to the unnecessary-sheet winding roller 47 of the drawing and winding means 45 which is located at a position shown by a two-dot chain line in FIG. 1.

When the wafer W is transferred by a transfer means (not shown) so as to be supported by the supporting convex portion 11A only in the lower surface side of the outer periphery portion of the wafer W, the drawing and winding means 45 moves from the position shown by the two-dot chain line in FIG. 1 to a position illustrated by a solid line in FIG. 1 in a state of locking the rotation of the drive roller 53. In synchronism with such movement, the winding means 41 is driven to collect the release liner RL. Thus, the adhesive sheet S passes over the first case 20 and is fed to the position where the adhesive sheet S faces the upper surface of the wafer W.

Next, the first case 20 is lifted, and the second case 21 is lowered, so that a single decompression chamber C is formed by the first and second cases 20 and 21 (see FIG. 3). In this state, the pressure in the decompression chamber C is reduced through the pipe 37 by controlling the solenoid valve 26.

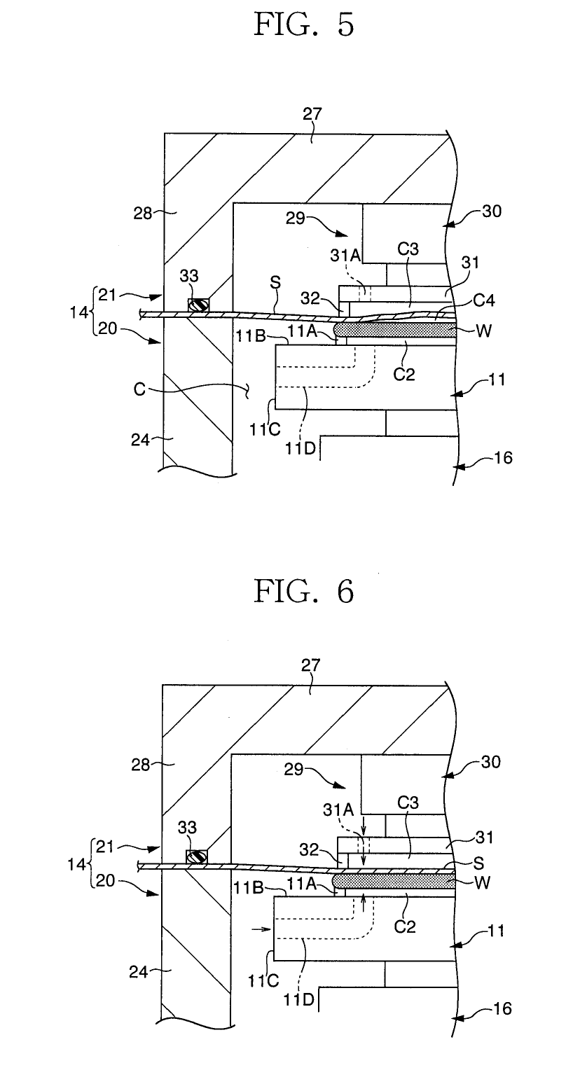

Then, when the decompression chamber C reaches to a decompression state, the table 11 is lifted, and the sandwiching plate 31 is lowered, so that the sandwiching convex portion 32 sandwiches only the outer periphery portion of the wafer W together with the adhesive sheet S by interaction with the supporting convex portion 11A. In this way, it can be prevented to apply a pressing force to an inner surface of the fragile wafer W, thereby preventing an external force from being applied to the surface on which a circuit is formed. Also, such sandwiching causes the formation of a space C4 existing before sticking (see, FIGS. 4 and 5) which is produced by no sandwiching force applied between the inner area of the wafer W and the adhesive sheet S. In this case, the space C2 on the lower surface side of the wafer W and the space C3 on the upper surface side of the adhesive sheet S form the single decompression chamber C in the case 14 by the communicating hole 11D formed in the table 11 and the through-hole 31A formed in the sandwiching plate 31, and in such a state, the space existing before sticking C4 is isolated from the decompression chamber C, thereby becoming an independent space.

In this way, the decompression chamber C is set to atmosphere pressure by controlling the three-way solenoid valve 26 to introduce the atmosphere from the pipe 38 after forming the space existing before sticking C4. As shown in FIG. 6, due to ventilation to atmosphere, the space existing before sticking C4 substantially disappears by the atmosphere pressure, so that the adhesive sheet S is stuck to the wafer W.

When sticking of the adhesive sheet S is completed, the second case 21 is lifted to open the case 14. The adhesive sheet S, then, is cut into a closed loop shape along the outer periphery of the wafer W through the cutting means (not shown).

After the cutting of the adhesive sheet S, the drive roller 53 and the unnecessary-sheet winding roller 47 move to the position shown by the two-dot chain line in FIG. 1 while the rollers 53 and 47 rotate in a state where the support roller 40 and the drive roller 50 are locked. Thus, the unnecessary adhesive sheet S1 resulting from the above cutting is wound.

The wafer W stuck with the adhesive sheet S is transported to a subsequent process or a predetermined storage locker through a conveying means (not shown), and a wafer W to be subjected to subsequent sticking is transferred on the table 11, and thereafter the adhesive sheet S is stuck thereto as well.

Therefore, according to the embodiment, the adhesive sheet S can be stuck within the single decompression chamber C without applying a pressing force to the surface inside of the wafer W. The adhesive sheet S can be stuck to the wafer W by forming the space existing before sticking C4 and controlling the pressure to return the decompression chamber C to atmosphere pressure to cause the space existing before sticking C4 to disappear. As a result, it is not required to perform complicated pressure control that reduces pressures in a plurality of decompression chambers while maintaining pressures in the decompression chambers at the same pressure, as a conventional manner, thereby greatly simplifying the decompression control in the decompression chamber C. Moreover, the wafer W has an arrangement in which the lower surface of the outer periphery side thereof is supported by the table 11, and therefore there is no disadvantage that the wafer W is damaged even when a foreign object such as dust is present on the upper surface of the table 11. Further, the sheet S can be stuck without trapping air bubble even when a concavity and convexity such as a bump is present on the adhered surface side of the wafer W.

Although the best configuration, method, and the like for carrying out the invention have been disclosed in the above description, the invention is not limited thereto.

Thus, the invention has been particularly illustrated and described mainly in terms of a specific embodiment, but those skilled in the art may make various modifications to the embodiments described above in term of shapes, quantities, and other detailed configurations without deviating from the scope of a technical idea and an object of the invention.

Accordingly, the description limiting the shapes and the like disclosed above is described as an example in order to facilitate understanding of the invention, and is not intended to limit the invention. Therefore, the descriptions of parts name without part or all of the limiting of the shapes and the like thereof are within the invention.

In the above embodiment, for example, the pressure sensitive adhesive sheet is used as the adhesive sheet S, but the present invention is not limited thereto, and may adopt a heat-sensitive adhesive sheet for die bonding and the like. In this instance, a heater may be built into the table 11, and air supplied through the pipe 25 may be hot air. Moreover, the adhesive sheet S may also be fed using an adhesive sheet of sheet-fed type.

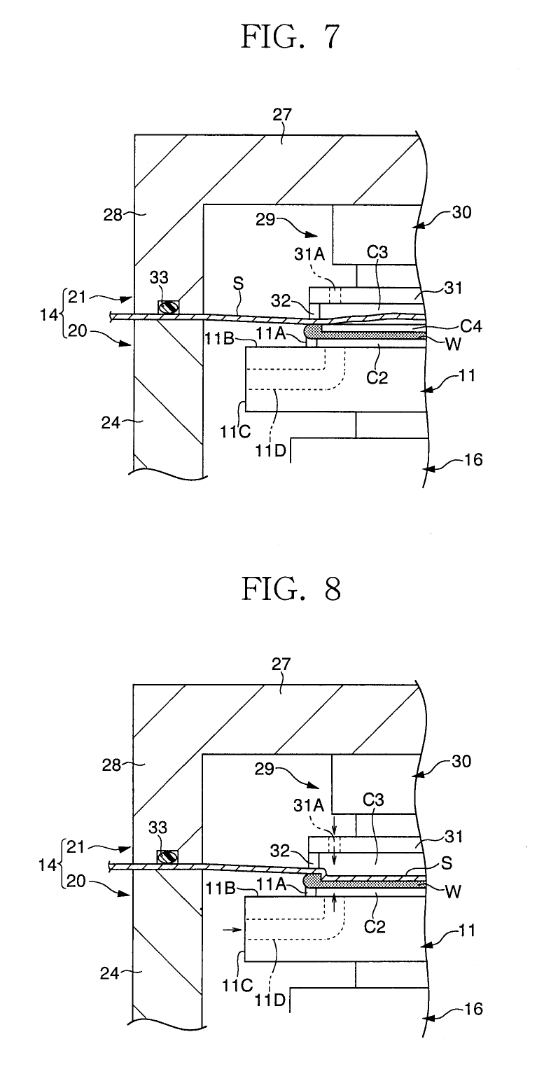

Further, the adherend is not limited to the wafer W, but may also cover plate-like members such as glass plates, steel plates, or resin plates. The semiconductor wafer may also be a silicon wafer or a compound wafer. Furthermore, the wafer W or the plate-like member is not limited to one having a uniform thickness. For example, as shown in FIGS. 7 and 8, the present invention may also apply to adherends of the type with a relatively large thickness in the outer periphery portion thereof.

What is claimed is:

1. A sheet sticking apparatus comprising a table for supporting an adherend, an openable and closeable case for accommodating the table and forming a decompression chamber in the case, and a feeding means for feeding an adhesive sheet to a position where the adhesive sheet faces the adherend, the adhesive sheet being stuck to the adherend by closing the case and performing a predetermined control of the pressure in the decompression chamber;
wherein the sheet sticking apparatus further comprising a sandwiching means disposed, in the case, in a position relative to the table, the sandwiching means being sandwiching only an outer periphery portion of the adherend together with the adhesive sheet by interaction with the table in a state where a single decompression chamber is formed by closing the case.

2. The sheet sticking apparatus according to claim 1, wherein the sandwiching means forms a space existing before sticking between the adhesive sheet and the adherend, the space being independent from the decompression chamber.

3. The sheet sticking apparatus according to claim 1 or 2, wherein the table comprises a supporting convex portion for supporting the outer periphery portion of the adherend from below; and the sandwiching means comprises a sandwiching convex portion corresponding to the supporting convex portion and sandwiching the adhesive sheet from top of the adhesive sheet.

4. A sheet sticking method using a sheet sticking apparatus including a table for supporting an adherend, an openable and closeable case for accommodating the table and forming a decompression chamber in the case, and a feeding means for feeding an adhesive sheet to a position where the adhesive sheet faces the adherend, the method comprising the steps of:
supporting a plate-like member on the table; feeding an adhesive sheet to a position relative to the plate-like member; forming a decompression chamber by closing the case; reducing the pressure in the decompression chamber; sandwiching only an outer periphery portion of the plate-like member together with the adhesive sheet by interaction with the table; and sticking the adhesive sheet to the plate-like member by releasing the reduced pressure in the decompression chamber.

5. The sheet sticking method according to claim 4, wherein the outer periphery portion of the plate-like member is sandwiched together with the adhesive sheet by a supporting convex portion for supporting an outer periphery portion of the adherend from below, and a sandwiching convex portion corresponding to the supporting convex portion and sandwiching the adhesive sheet from top of the adhesive sheet.
